(19) United States
(12) Patent Application Publication
(10) Pub. No.: US 2006/0119886 A1
(43) Pub. Date: Jun. 8, 2006

(54) Print control unit and a print control program

(76) Inventor: Masaya Nemoto, Kanagawa (JP)

Correspondence Address: DICKSTEIN SHAPIRO MORIN & OSHINSKY LLP, 2101 L Street, NW, Washington, DC, 20037, US

(21) Appl. No.: 11/274,236

(22) Filed: Nov. 16, 2005

(30) Foreign Application Priority Data
Nov. 18, 2004 (JP) 2004-334564

(51) Int. Cl. G06F 3/12

(52) U.S. Cl. 358/1.15

(57) ABSTRACT

A print control unit is disclosed that converts document data in which a print request thereof is made into print data interpretable by a print device and directing the print device to print out the print data. The print control device includes a receiving unit receiving the print request for the document data together with operator discriminating information discriminating an operator and document discriminating information discriminating the document data, a document data obtaining unit obtaining the document data corresponding to the print request according to the document discriminating information and a print data generating unit generating the print data so as to print out the document data obtained by the document data obtaining unit and at least the operator discriminating information.

### BACKGROUND OF THE INVENTION

1. Field of the Invention

The present invention generally relates to a print control unit and a print control program, and especially to a print control unit and a print control program where document data for which a print request thereof is made are converted into print data interpretable by a print device, and the print device prints out the print data.

2. Description of the Related Art

In recent years and continuing, awareness of security is improved, and the same goes for documents registered in document management systems. For example, there are provided many document management systems performing access control for the registered documents. According to the access control, user access to each of the documents can be regulated. In the document management system, the documents are effectively prevented from being misused.

The document management systems disclosed by Japanese laid-open patent application No. 2000-215095 may be used.

However, once important resources such as a classified document are printed out on paper by a user who clears the access control, the management of the printed paper is left in the hands of the user. Accordingly, anyone can easily access the printed paper; thus, it is conceivable that the important resources may be left unprotected by a viper and exposed to anyone. Therefore, it is necessary to improve the user's awareness on dealing with the important resources.

### SUMMARY OF THE INVENTION

It is a general object of the present invention to provide a print control unit and a print control program that substantially obviate one or more problems caused by the limitations and disadvantages of the related art.

Features and advantages of the present invention are presented in the description which follows, and in part will become apparent from the description and the accompanying drawings, or may be learned by practice of the invention according to the teachings provided in the description. Objects as well as other features and advantages of the present invention will be realized and attained by the print control unit and the print control program particularly pointed out in the specification in such full, clear, concise, and exact terms as to enable a person having ordinary skill in the art to practice the invention.

To achieve these and other advantages in accordance with the purpose of the invention, an embodiment of the present invention provides a print control unit converting document data in which a print request thereof is made into print data interpretable by a print device and directing the print device to print out the print data. The print control device includes a receiving unit receiving the print request for the document data together with operator discriminating information for discriminating an operator and document discriminating information discriminating document data, a document data obtaining unit obtaining the document data corresponding to the print request according to the document discriminating information and a print data generating unit generating the print data so as to print out the document data obtained by the document data obtaining unit and at least the operator discriminating information.

In such a print control unit, the document data are printed out together with the information for discriminating the operator. Accordingly, it is easy to specify the operator who prints out the document; thus, the operator's awareness on dealing with the printed paper can be improved.

According to the present invention, a print control unit and a print control program can be provided improving the user's awareness on dealing with the printed paper.

### BRIEF DESCRIPTION OF THE DRAWINGS

Other objects and further features of the present invention will be apparent from the following detailed description when read in conjunction with the accompanying drawings, in which:

FIG. 1 is a view illustrating a configuration example of a document management system according to an embodiment of the present invention;

FIG. 2 is a view illustrating a configuration example of document data management of a document management server according to the embodiment of the present invention;

FIG. 3 is a view illustrating a screen example of a new cabinet creating dialogue box;

FIG. 4 is a view illustrating a configuration example of functions of a print server according to the embodiment of the present invention;

FIG. 5 is a view illustrating a hardware configuration example of the print server according to the embodiment of the present invention;

FIG. 6 is a flowchart for explaining a print request receiving process of the print server;

FIG. 7 is a view illustrating a screen example of a print instructing dialogue box;

FIG. 8 is a flowchart for explaining a print job executing process of the print server;

FIG. 9 is a view illustrating a print image example on which print character strings are printed; and

FIG. 10 is a view illustrating a configuration example of an image forming device realizing the print control function, the document management function, and the print function.

### DESCRIPTION OF THE PREFERRED EMBODIMENTS

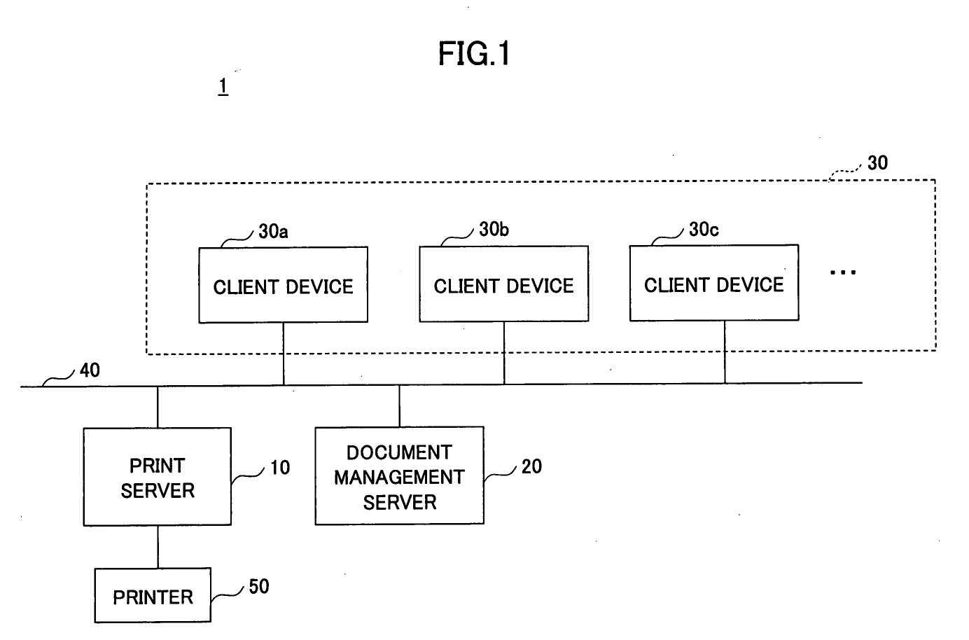

In the following, embodiments of the present invention are described with reference to the accompanying drawings. FIG. 1 is a view illustrating a configuration example of a document management system 1 according to an embodiment of the present invention. In FIG. 1, the document management system 1 is configured to include a print server 10, a document management server 20, a unit of client devices including at least one or more client devices such as client devices 30a, 30b and 30c (hereinafter, “client device 30” is given as a generic name) which are connected via a LAN (Local Area Network) or network 40 such as the Internet (network 40 can be configured by both wire and wireless).

The print server 10 is a computer including a function of print control on which a print control function is mounted so as to direct a printer 50 to print out the document data stored in the document management server 20 which is described below. The print server 10 is a specific example of a print control unit in the present embodiment. The print server 10 responds to a print request for the document data from the document management server 20, obtains the document data specified by the print request from the document management server 20, converts the document data into print data interpretable by the printer 50 and directs the printer 50 to print out the converted print data. It should be noted that the document data are a conception including various electronic data to be a print object such as not only data created by a general word processor application but also data created by a spreadsheet application, image data scanned by a scanner and the like.

The document management server 20 is a computer including a function of document data management. The document management server 20 accumulates document data such as document data created by a predetermined application in the client device 30, and document data read by a scanner together with bibliographic information. The document management server 20 searches, registers, updates and deletes the document data corresponding to a request from the client device 30 and the print server 10.

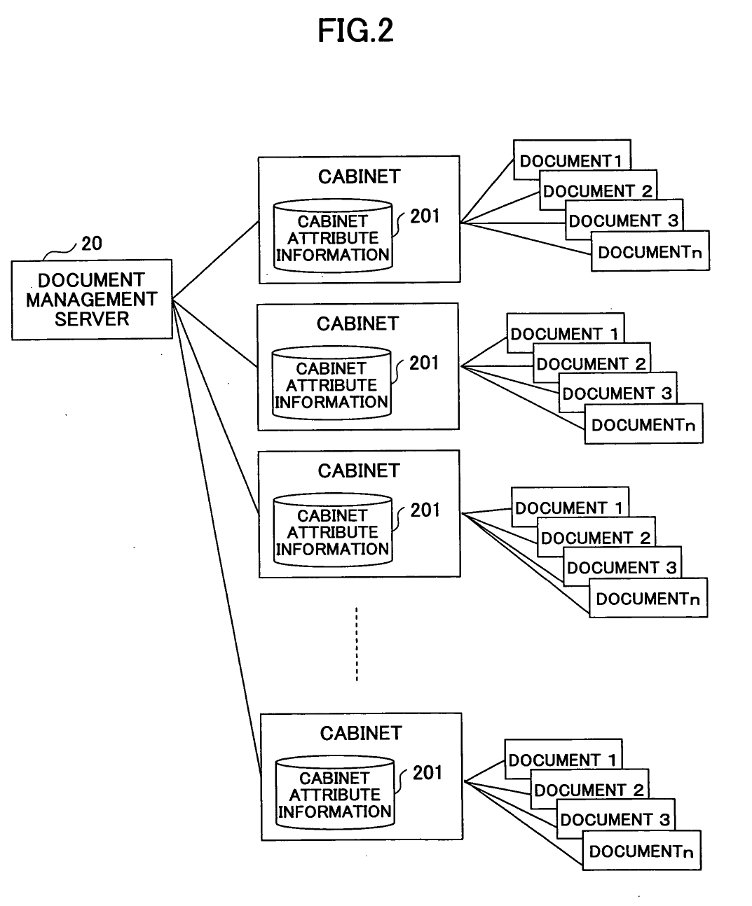

FIG. 2 is a view illustrating a configuration example of document data management of the document management server 20 according to the embodiment of the present invention. As shown in FIG. 2, the document management server 20 manages the document data by classifying them with a concept called a cabinet. One document management server 20 can define plural cabinets. One cabinet can store plural document data sets.

Each cabinet is associated with cabinet attribute information 201. The cabinet attribute information 201 includes the contents of the document data and a print state such as strings to be printed and a position of the strings at a time of printing. The cabinet attribute information 201 is set, for example, by a system administrator at a time of creating a cabinet.

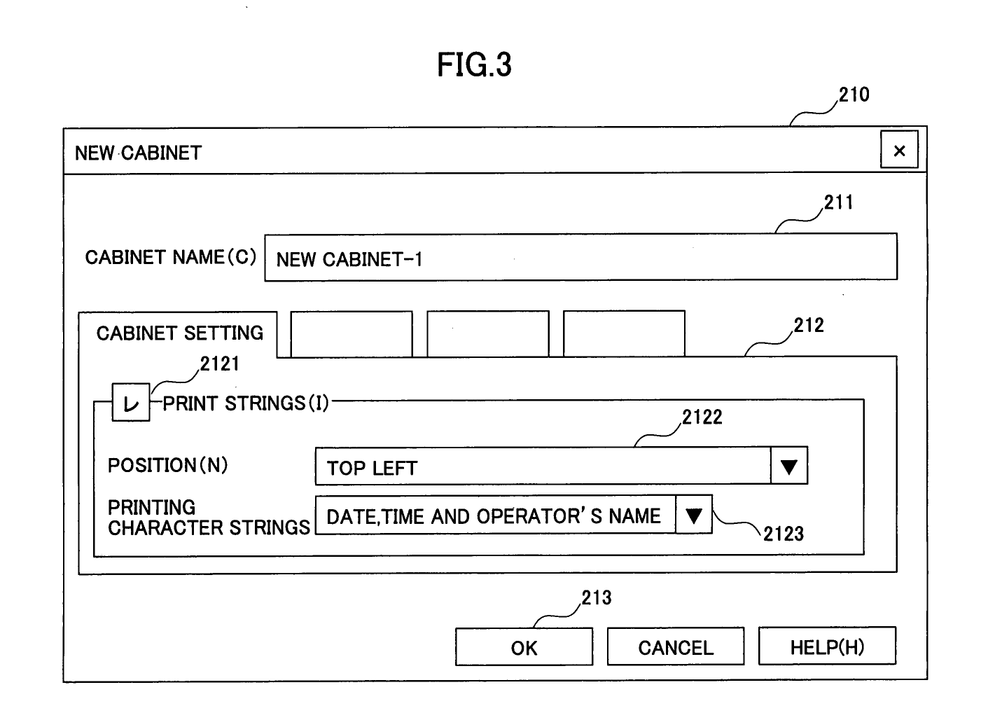

FIG. 3 is a view illustrating a screen example of a new cabinet creating dialogue box 210. The new cabinet creating dialogue box 210 shown in FIG. 3 is displayed at a time of creating a new cabinet in the document management server 20 on the screen of the document management server 20 or another device (for example, client device 30b or 30c and the like) for controlling the document management server 20 via a network. The new cabinet creating dialogue box 210 includes a cabinet name input field 211 and a print information setting field 212. The cabinet name input field 211 is provided for inputting the name of a cabinet to be newly created.

The cabinet information setting field 212 is provided for setting the cabinet attribute information 201. The cabinet information setting field 212 includes a checkbox 2121, a print position selecting field 2122, and a print character strings specifying field 2123. The print character strings specifying field 2123 is provided for specifying the strings (hereinafter, referred to as strings) to be printed out on the archival paper together with the contents of the document data. The print position selecting field 2122 is provided for selecting the printing position of the strings on the archival paper. As the printing position, for example, top left, upper middle, top right, lower left, lower middle, and lower right can be selected.

The checkbox 2121 is provided for determining whether a user may print out the specified strings. When the checkbox 2121 is checked, the strings are printed out. FIG. 3 shows a setting example of printing the date, time and the operator's name on the top left of the archival paper. Here, the date and time mean the date and time when the printing is executed, and the operator's name means the name of the user who makes a print request in the client device 30.

It should be noted that the cabinet attribute information 201 is set in the new cabinet creating dialogue box 210. When the OK button 213 is clicked, a new cabinet is created on the document management server 20. Then, the cabinet attribute information 201 is associated with the cabinet.

According to the new cabinet creating dialogue box 210 shown in FIG. 3, it is necessary to set cabinet attribute information 201 for each cabinet. It is also possible to provide a dialogue box setting the same cabinet attribute information 201 for every cabinet all at once. Moreover, information corresponding to the cabinet attribute information 201 can be set for each of the document data sets.

Returning to FIG. 1, the client device 30 is a computer making a print request for the document data accumulated on the document management server 20 to the print server 10. At this time, as an argument of the print request, document data discriminating information for discriminating the operator's name and the document data to be printed out is transmitted to the print server 10. It should be noted that the client device 30 according to the present embodiment includes not only the devices which the user directly uses but also the devices transmitting a print request from the Web browser to the print server 10 such as a Web server in the Web environment. In other words, the client device 30 includes all devices transmitting a print request to the print server 10.

It should be noted that it is not necessary that the print server 10 and the document management server 20 be separate hardware. The present invention can apply to hardware realizing itself as a function of print control in the print server 10 and a function of document data management in the document management server 20.

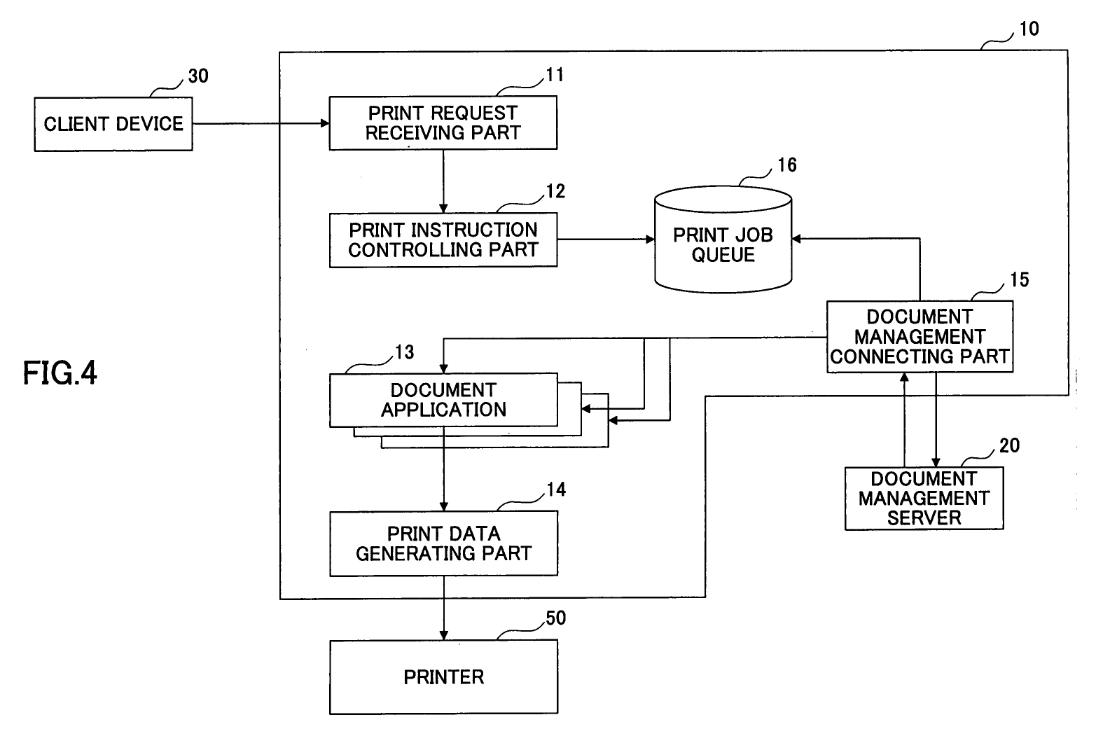

FIG. 4 is a view illustrating a configuration example of functions of a print server according to the embodiment of the present invention. As shown in FIG. 4, the print server 10 includes a print request receiving part 11, a print instruction controlling part 12, a document application 13, a print data generating part 14, a document management connecting part 15 and a print job queue 16.

The print request receiving part 11 receives a request message from the client device 30 and analyzes the contents of the request message so as to direct the print instruction controlling part 12 to perform execution of processing corresponding to the request from the client device 30. For example, when the request message from the client device 30 is made for printing document data, the print request receiving part 11 directs the print instruction controlling part 12 to execute printing the document data.

The print instruction controlling part 12 has a function of registering the contents of the print instruction from the print request receiving part 11 (for example, an operator's name, document data discriminating information and the like) in the print job queue 16. Even if the print instruction controlling part 12 registers the contents of the print instruction in the print job queue 16, the printing is not started immediately and the control is returned to the print request receiving part 11 (for example, in a case of a function call, RETURN is set). In other words, the print instruction from the print instruction controlling part 12 is not synchronously executed so as to make a response to the client device 30 immediately.

The document application 13 such as a word processor, a spreadsheet and the like is provided for creating and editing the document data. Each application corresponds to its own kind of document data.

The print data generating part 14 is a function of converting the document data which are print objects into data for printing (hereinafter, referred to as “print data”) where the specified printer 50 can interpret the format thereof (for example, PDL (Page Description Language)). As a specific example, a printer driver corresponds to the print data generating part 14.

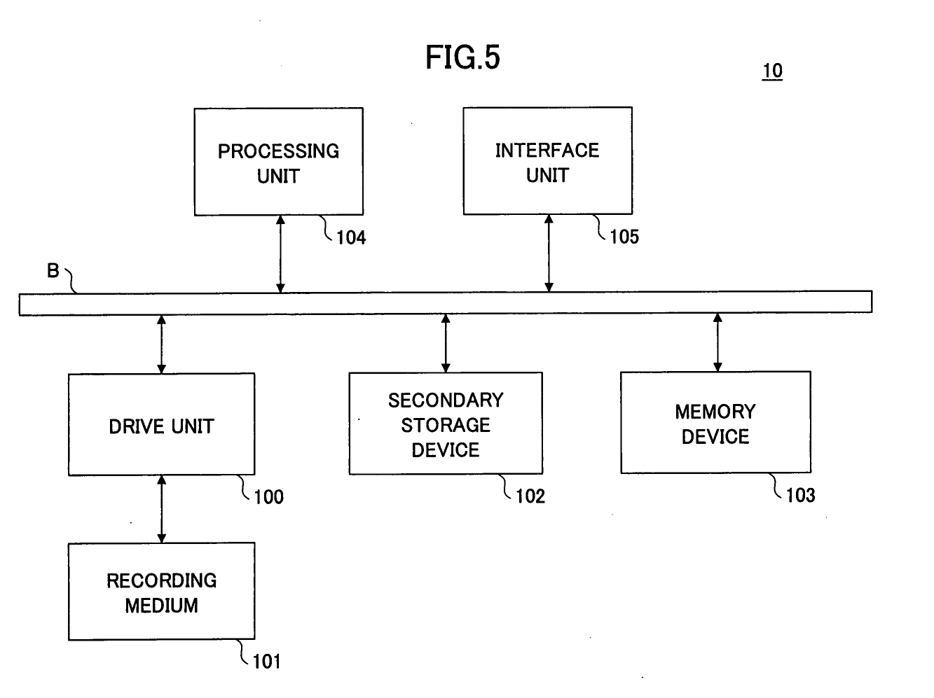

FIG. 5 is a view illustrating a hardware configuration example of the print server according to the embodiment of the present invention. The print server 10 shown in FIG. 5 includes a drive unit 100, a secondary storage device 102, a memory device 103, a processing unit 104 and an interface unit 105. Each one is connected by bus B.

A program for processing in the print server 10 is provided by a recording medium 101 such as a CD-ROM, when the recording medium 101 on which the program is recorded is set in the drive unit 100. Then, the program is installed on the secondary storage device 102 via the drive unit 100.

The secondary storage device 102 stores the installed program and the other necessary files and data. The memory device 103 reads the program from the secondary storage device 102 and temporarily stores the program when program execution is directed. The processing unit 104 realizes each function shown in FIG. 4 by processing the program temporarily stored in the memory device 103. The interface unit 105 including, for example, a modem, a router and the like is used for connecting the devices and units to the network 40 shown in FIG. 1.

It should be noted that the document management server 20 and the client device 30 can include the same hardware configuration that the print server 10 shown in FIG. 5 includes.

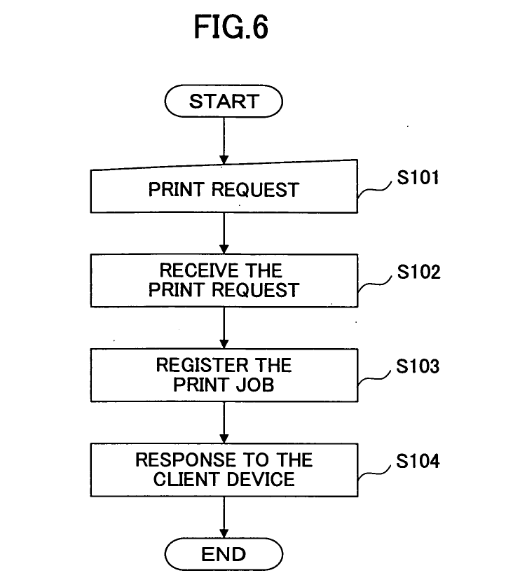

A description is given of a procedure of the print server 10 shown in FIG. 4. FIG. 6 is a flowchart for explaining a print request receiving process of the print server 10. At a time of start shown in FIG. 6, the client device 30 displays a list (hereinafter, referred to as “a document data list screen”) of the document data searched in the document management server 20.

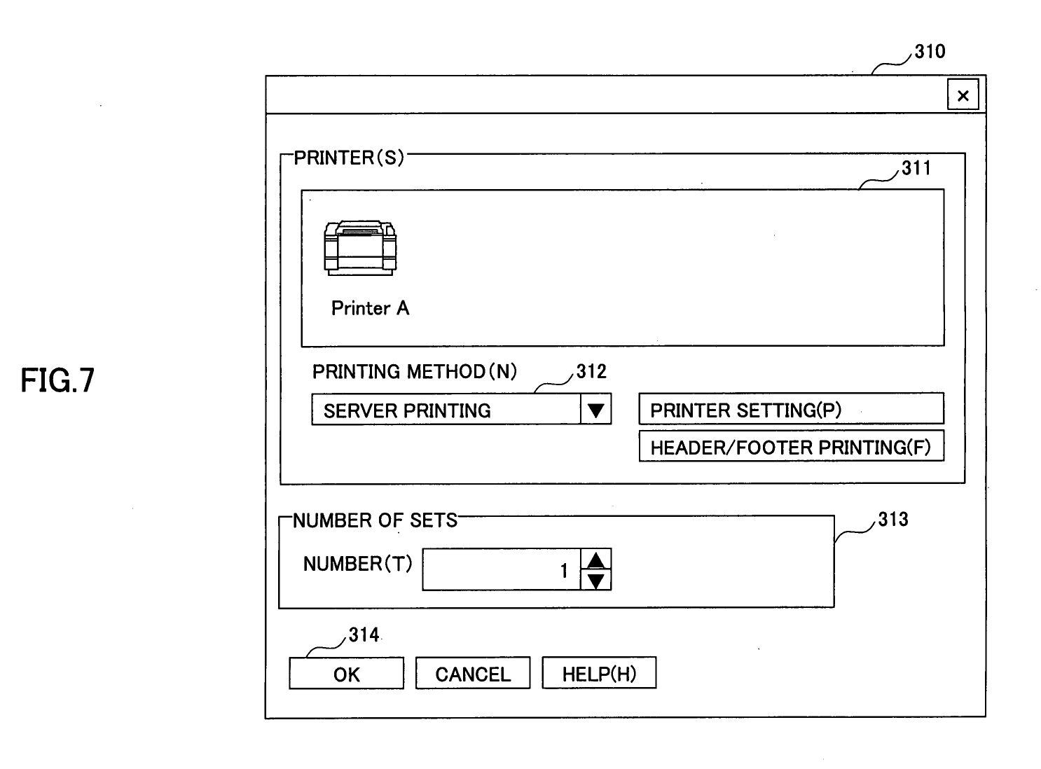

In step S101, the user of the client device 30 selects the document data to be printed out from the document data list and directs printing by transmitting a request message for printing the object document data from the client device 30 to the print server 10. Operations for directing printing in the client device 30 are performed, for example, through a dialogue box shown in FIG. 7.

FIG. 7 is a view illustrating a screen example of a print instruction dialogue box. The print instruction dialogue box 310 shown in FIG. 7 includes a printer selecting field 311, a printing method selecting field 312 and a number of sets (copies) specifying field 313. The printer selecting field 311 displaying icons corresponding to the available printers is provided for selecting the printer. The printing method selecting field 312 is provided for selecting the printing method. For example, when “server printing” is selected as the printing method, printing by the printer driver installed on the client device 30 is not performed, while printing using a function of the print data generating part 14 of the print server 10 is performed. In the present embodiment, an example is given of “server printing” being selected. The number of sets specifying field 313 is provided for specifying the number of sets.

When the print setting is performed in the print instruction dialogue box 310 and the OK button 314 is clicked, the above described request message is transmitted to the print server 10. The request message includes an argument such as an operator's name and an object document data ID. The object document data ID assigned to the object document data is a specific example of the document data discriminating information. It should be noted that in the present embodiment, the user can specify the cabinet to which the object document data belong based on the object document data ID.

In step S102, the print request receiving part 11 of the print server 10 receives a request message and directs the print instruction controlling part 12 to print out the object document data based on the request message. In step S103, the print instruction controlling part 12 issues a job ID for discriminating each print job to be executed corresponding to the print instruction and registers information (hereinafter, referred to as “print job information”) associating the issued job ID with the operator's name specified by the argument of the request message and the object document data ID on the print job queue 16. It should be noted that the print instruction controlling part 12 at this moment does not execute printing immediately (synchronously with the print instruction) and returns the newly issued job ID to the print request receiving part 11.

In step S104, the print request receiving part 11 replies with the returned job ID from the print instruction controlling part 12 to the client device 30 and terminates the print request receiving process. It should be noted that the job ID reported to the client device 30 is stored in the client device 30 and used when, for example, making an inquiry of the print job state.

Accordingly, when the print server 10 receives the print request from the client device 30, the print server 10 registers the print job information on the print job queue 16 temporarily and makes a response to the client device 30 before starting printing. Therefore, the client device 30 is released early from waiting for the response; thus, the user can proceed to the next operation immediately.

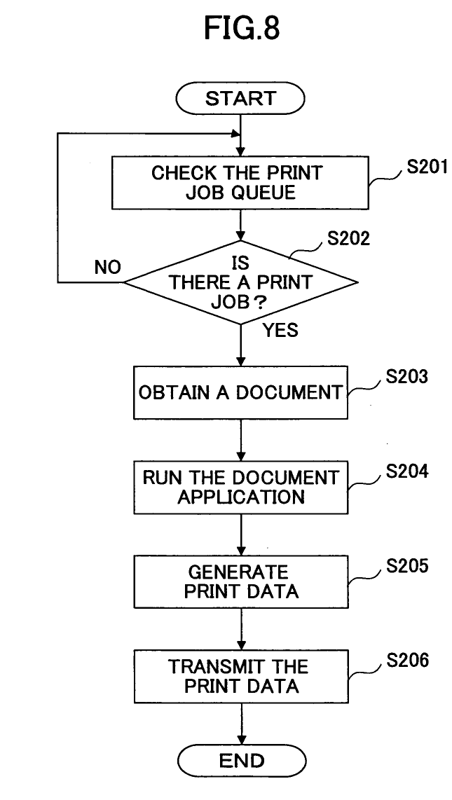

Next, a description is given of executing the print job registered in the print job queue 16. FIG. 8 is a flowchart for explaining a print job executing process of the print server.

In the print server 10, a document management connecting part 15 regularly refers to the print job queue 16 so as to attempt to obtain print job information (S201 and S202). The reference is performed asynchronously with the procedures shown in FIG. 6. When the print job information is obtained (in the case of “Yes” in step S202), the procedure proceeds to step S203. When the document management connecting part 15 makes a request for transmitting object document data (hereinafter, referred to as “object data”) according to the object document data ID in the print job information to the document management server 20, the object data are supplied from the document management server 20. In this case, the document management server 20 specifies the cabinet to which the object document data belong according to the document data ID and replies with the object data and the cabinet attribute information 201 associated with the cabinet to the print server 10.

In step S204, the document management connecting part 15 runs the document application 13 corresponding to the type of the object data and directs the document application 13 to print out the object data. It should be noted that the application corresponding to the type of the object data is specified by a publicly known method such as checking the suffix (file name extention). The document application 13 converts the document data from the document management connecting part 15 into a file to be saved temporarily (hereinafter, referred to as “an intermediate file”), and then, makes a request for generating print data to the print data generating part 14.

In step S205, the print data generating part 14 converts the intermediate file into interpretable print data for the printer 50. Then, the print data generating part 14 generates print data according to the cabinet attribute information 201 so as to print out the strings. For example, “date, time and operator's name” are specified in the cabinet attribute information 201 as the strings to be printed. The printing position of the strings is set “top left”. Accordingly, the print data generating part 14 adds information associated with, for example, the strings and the printing position thereof as a print control command when converting the intermediate file into the print data.

When the printing position overlaps a position of a header area or a footer area (blank areas of the upper or lower part of the print image) of the print image of the document data, the strings and images displayed on the header and footer overlap the print character strings. As a result, the print character strings cannot be recognized clearly on the paper. For example, when the header area and the footer area are blacked out, the print character strings cannot be read. In this case, the print data generating part 14 automatically moves the printing position of the print character strings to a proper position so as to prevent the printing position from overlapping the header area or the footer area.

Specifically, when the intermediate file is converted into the print data, the printing position is changed according to a starting position of the header area or an ending position of the footer area (for example, a coordinate value on the archival paper), a position of strings on the header area or the footer area and information such as a font size or image information written as the print control command in the print data. For example, if the print character strings overlap the header position, the printing position of the strings is corrected by being moved above the header. If the print character strings overlap the footer position, the printing position of the strings is corrected by being moved below the footer.

The printing position is automatically corrected. Therefore, when the user notices that the print character strings overlap the strings or images on the header area or the footer area after printing, it is not necessary for the user to reset the cabinet attribute information 201.

In step S206, the print date generated by the print data generating part 14 is transmitted to the printer 50. The printer 50 executes printing according to the print control command in the print data. Accordingly, when a command for outputting the print character strings is added to the print data, the specified print character strings are printed at the specified printing position.

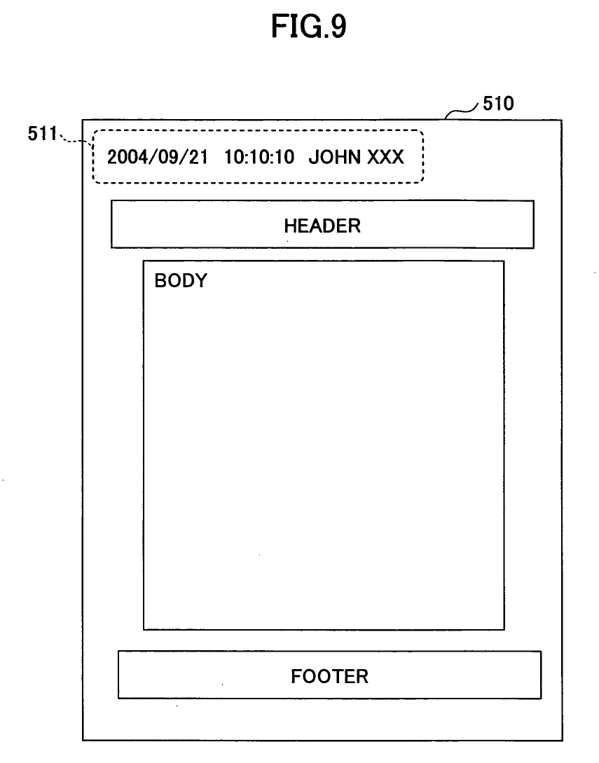

FIG. 9 is a view illustrating a print image example on which print character strings are printed. In the paper 510 shown in FIG. 9, the date, time and the operator's name are printed on the top left of the paper 510 as the print character strings 511. Accordingly, when the paper 510 is left unprotected, or when the paper 510 is not properly dealt with because of loose management, the user who printed the paper 510 can be easily specified.

As described above, the print server 10 according to the present invention can forcibly print predetermined character strings at a predetermined position. Accordingly, if print strings are set as, for example, an operator's name, it is easy to specify the user who printed the paper. Therefore, it becomes possible to clarify where the responsibility for such as a disclosure of important document data lies. In addition, it becomes possible to promote users' awareness on the security management of the printed papers.

The operator's name is used as the operator discriminating information in the above description. However, it should be noted that it is not necessary to use the operator's name as the operator discriminating information as long as the information can specify the operator. For example, employees' ID, the name of the computer which sends print data, the name of the printer which prints the data, the name of the print job and the like can be used. Moreover, the printing position is not limited to the above description. The character strings can be printed at any position on the archival paper. Furthermore, the print character strings can be arbitrary strings. The size of the print character strings, the color density and the like can also be set.

As a related matter, in these years, a built-in device which is specialized in a specific function has the same process as a computer executing information processing. For example, the device corresponds to an image forming device called a complex machine or fused machine including plural applications executing processing which is specific to multiple services such as a printer, a copier and a facsimile machine. Recent image forming devices include a function as a Web server. Moreover, some image forming devices further include a document management function such as accumulating information of a copied paper and a received fax as document data.

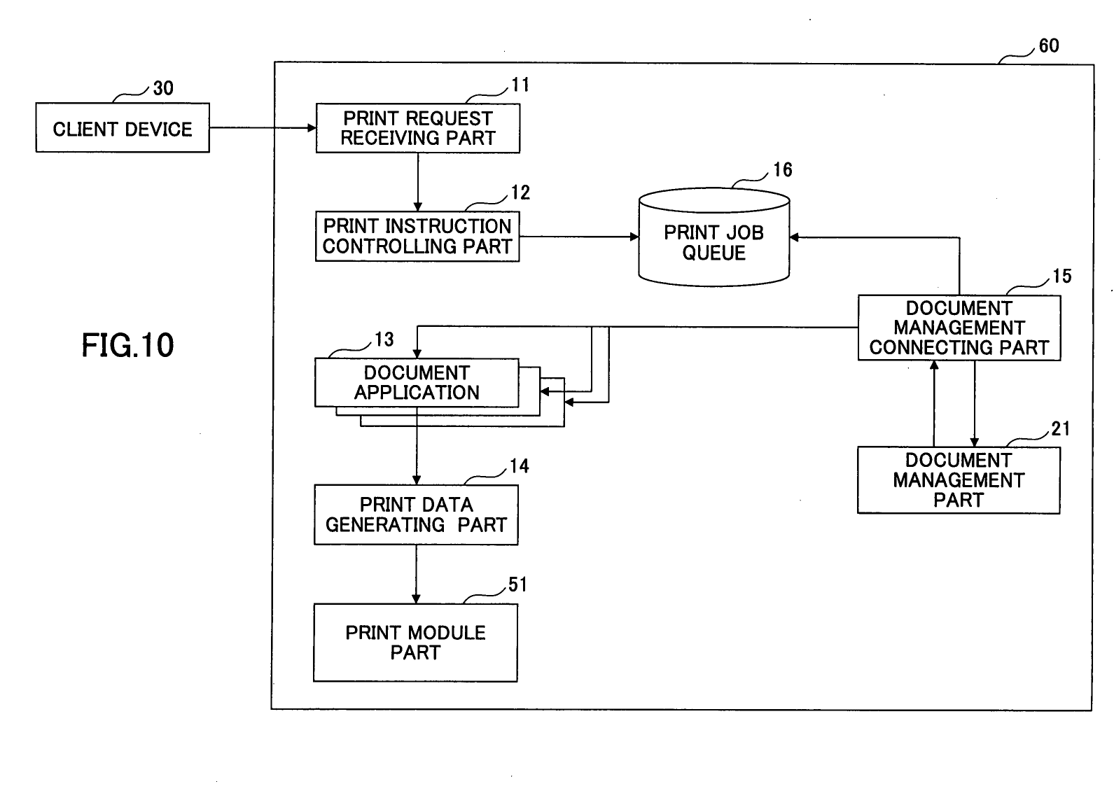

Accordingly, it is possible to realize the print control function of the print server 10, document management function of the document management server 20 and print function of the printer 50 by one image forming device. FIG. 10 is a view illustrating a configuration example of an image forming device realizing the print control function, the document management function and the print function. In FIG. 10, the image forming device 60 includes a document management part 21 and a print module part 51 in addition to the functions of the print server 10. The document management part 21 is a software module playing the document management function of the document management server 20. The print module part 51 comprises a hardware module and a software module playing the print function of the printer 50. Accordingly, the image forming device 60 itself can realize functions of the print server 10, the document management server 20 and the printer 50.

Further, the present invention is not limited to these embodiments, but variations and modifications may be made without departing from the scope of the present invention.

The present application is based on Japanese Priority Application No. 2004-334564 filed on Nov. 18, 2004, with the Japanese Patent Office, the entire contents of which are hereby incorporated by reference.

What is claimed is:

1. A print control unit converting document data wherein a print request thereof is made into print data interpretable by a print device and directing said print device to print out the print data, comprising:
a receiving unit receiving said print request for the document data together with operator discriminating information discriminating an operator and document discriminating information discriminating the document data;
a document data obtaining unit obtaining the document data corresponding to the print request according to the document discriminating information; and
a print data generating unit generating the print data so as to print out the document data obtained by the document data obtaining unit and at least the operator discriminating information.

2. The print control unit as claimed in claim 1, wherein said document data obtaining unit obtains the document data corresponding to the print request and print information indicating a printing condition of the operator discriminating information associated with the document data, and wherein said print data generating unit adds the operator discriminating information to the print data so as to print out the operator discriminating information according to the printing condition of the print information.

3. The print control unit as claimed in claim 2, wherein said print data generating unit adds a name of the operator and/or date and time of printing, based on the print information, to the print data.

4. The print control unit as claimed in claim 2, wherein said print information includes position information where the operator discriminating information is to be printed, and when the position information of the print information overlaps a predetermined position in a print image of the document data, the print data generating unit adds the operator discriminating information to the print data so as to print out the operator discriminating information at a position different from the position indicated by the position information.

5. The print control unit as claimed in claim 4, wherein said print data generating unit determines a printing position of the operator discriminating information based on a position of strings to be printed on a header area or a footer area in the print image of the document data.

6. The print control unit as claimed in claim 5, wherein said print data generating unit determines a printing position of the operator discriminating information based on a font size of the strings to be printed on the header area or the footer area in the print image of the document data.

7. A computer-readable recording medium containing a print control program for directing a computer to perform the steps of:
receiving operator discriminating information discriminating an operator and document discriminating information discriminating document data being sent at a time of receiving a print request for the document data;
obtaining the document data corresponding to the print request according to the document discriminating information;
generating print data interpretable by a print device according to the document data so as to print out the document data obtained in the obtaining step with at least the operator discriminating information; and
transmitting the print data generated in the generating step to the print device.

8. The computer-readable recording medium containing the print control program as claimed in claim 7, wherein said document data obtaining step obtains the document data corresponding to the print request and print information indicating a printing condition of the operator discriminating information associated with the document data, and wherein said print data generating step adds the operator discriminating information to the print data so as to print out the operator discriminating information according to the printing condition of the print information.

9. The computer-readable recording medium containing the print control program as claimed in claim 8, wherein said print data generating step adds the operator's name and/or date and time of printing to the print data based on the print information.

10. The computer-readable recording medium containing the print control program as claimed in claim 8, wherein said print information includes position information where the operator discriminating information is to be printed, and when a position indicated by the position information where the print information to be printed overlaps a predetermined position in a print image of the document data, the print data generating step adds the operator discriminating information to the print data so as to print out the operator discriminating information at a position different from the position indicated by the position information.

11. The computer-readable recording medium containing the print control program as claimed in claim 10, wherein said print data generating step determines a position where the operator discriminating information is to be printed based on a position of strings to be printed on a header area or a footer area in the print image of the document data.

12. The computer-readable recording medium containing the print control program as claimed in claim 10, wherein said print data generating step determines a position where the operator discriminating information is to be printed based on a font size of strings to be printed on a header area or a footer area in the print image of the document data.
